(19) United States
(12) Patent Application Publication
(10) Pub. No.: US 2009/0027911 A1
(43) Pub. Date: Jan. 29, 2009

(54) Vehicular lamp

(75) Inventors: Akihiro Misawa, Aichi-Ken (JP); Tatsuya Oba, Aichi-ken (JP); Tetsuya Arakawa, Aichi-ken (JP); Akihiko Ishikawa, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 12/219,144

(22) Filed: Jul. 16, 2008

(30) Foreign Application Priority Data
Jul. 17, 2007 (JP) 2007-185125

(51) Int. Cl. F21S 8/10; F21V 7/00

(52) U.S. Cl. 362/518; 362/545

(57) ABSTRACT

The invention is constituted by a vehicular lamp characterized in a lens having a first light source, a second light source, a front light emitting face, a side end face to which the first light source is opposed, and a rear face, wherein the rear face includes a lens having pluralities of reflecting portions and transmitting portions consecutively aligned alternately in a direction of being remote from the side end face, and a reflecting face arranged on a rear side of the lens, light of the first light source is incident on the lens from the side end face of the lens, reflected by an interface of the reflecting portion, thereafter, radiated from the front light emitting face, and light of the second light source is reflected by the reflecting portion, thereafter, incident on the lens from the transmitting portion and radiated from the front light emitting face.

### BACKGROUND OF THE INVENTION

1. Field of the Invention

The present invention relates to a vehicular lamp. In details, the invention relates to an improvement in a vehicular lamp of a rear combination lamp or the like.

2. Description of the Related Art

According to a vehicular lamp of a rear combination lamp, a high mounted stop lamp or the like, generally, desired light emission is achieved by utilizing light of a plurality of kinds of light sources. For example, Patent Reference 1 discloses a rear combination lamp including two kinds of light sources (LED lamp for stop lamp and LED lamp for turn lamp) and a lens. According to the rear combination lamp, by subjecting a portion of a lens front face to metal vapor deposition, an outer reflecting portion is formed. On the other hand, a portion of a lens rear face is inclined and an inner reflecting portion is formed by an interface thereof. Further, a stop lamp is lighted by reflecting light of an LED lamp for a stop lamp by an outer reflecting face, thereafter, radiating the light to outside. On the other hand, a turn lamp is lighted by guiding light of an LED lamp for a turn lamp to inside of a lens, reflecting the light by the inner reflecting portion, thereafter, radiating the light to outside.

Patent Reference 1: JP-A-2006-313681

According to the rear combination lamp, a reflection treatment for forming a reflecting face at a lens front face is needed. Therefore, fabricating steps increase, as a result, fabrication cost is increased.

### SUMMARY OF THE INVENTION

Hence, it is an object of the invention to provide a vehicular lamp having a high design performance and capable of being fabricated at low cost.

The invention is constructed by the following constitution in order to resolve the above-described problem. That is, there is provided a vehicular lamp characterized in including:

a first light source;

a second light source;

a lens having a front light emitting face, a side end face to which the first light source is opposed, and a rear face, which is a lens in which the rear face includes pluralities of reflecting portions and transmitting portions alternately aligned consecutively in a direction of being remote from the side end face; and

a reflecting face arranged rearward from the lens;

wherein light of the first light source is incident on the lens from the side end face of the lens, reflected by an interface of the reflecting portion, thereafter, radiated from the front light emitting face; and

wherein light of the second light source is reflected by the reflecting face, and is incident on the lens from the transmitting portion and radiated from the front light emitting face.

According to the above-described constitution, the light of the first light source is reflected by the interface reflection of the reflecting portion of the lens rear face. On the other hand, the light of the second light source is reflected by the reflecting face, incident on a light guiding member from the transmitting portion of the lens rear face and is irradiated from the front light emitting face. The invention is constituted in this way, and therefore, the reflection treatment is not needed at the lens surface. Fabricating steps are simplified and fabrication cost is reduced. On the other hand, both of the light of the first light source and the light of the second light source are radiated from the front light emitting face of the lens. The light of the first light source and the light of the second light source are radiated from the same light emitting face in this way, and therefore, a unified feeling of a light emission mode is increased and a design performance is promoted.

### BRIEF DESCRIPTION OF THE DRAWINGS

FIG. 1 is a view for explaining an angle of a face rectifying a reflecting portion.

FIG. 2 is a perspective view of a rear combination lamp 1 constituting an example of the invention.

FIG. 3 is a vertical sectional view at an A-A line position of FIG. 2.

FIG. 4 is a vertical sectional view of a rear combination lamp 100 constituting other example of the invention.

FIG. 5 is a vertical sectional view of a rear combination lamp 500 constituting still other embodiment of the invention.

### DESCRIPTION OF THE PREFERRED EMBODIMENTS

According to the vehicular lamp of the invention, the light of the first light source introduced to the lens is converted into the light in the front light emitting face direction of the lens by reflecting the light by the reflecting portion of the lens. Thereby, the light is irradiated finally from the front light emitting face. Further, the light of the second light source reflected by the reflecting face is converted into light in the front light emitting face direction by making the light incident on the lens from the transmitting portion of the lens rear face. Thereby, the light is irradiated finally from the front light emitting face. As described above, according to the invention, the front light emitting face of the lens becomes an outer surface of the lamp. That is, when the lamp of the invention is viewed from outside, the light emitting face of the lens is observed directly (not by way of a cover or the like). Further, the front light emitting face of the lens is not subjected to the reflection treatment at all and when the front light emitting face of the lens constituting the outer surface of the lamp is observed, a similar glossiness feeling or a crystal feeling is felt over a total thereof. A high design performance is achieved in this way. Further, it is advantageous also for promoting a weather resistance that it is not necessary to subject the front light emitting face of the lens to the reflection treatment.

The first light source and the second light source are used in the vehicular lamp of the invention. Kinds of the first light source and the second light source are not particularly limited but LED lamps, bulbs or the like can be used. It is preferable to use an LED lamp thereamong. Because small-sized formation of the lamp can be achieved since the LED lamp is small-sized. Further, the LED lamp also achieves an advantage that an influence of heat to a surrounding member can be reduced since a heat generating amount thereof is small. Further, the LED lamp also achieves an advantage that a drive power thereof is small and service life is long. Although the kind of the LED lamp is not particularly limited and various types of LED lamps of a shell type, a chip type and the like can be adopted, an LED lamp having a high directivity including a lens or the like is particularly preferable. The first light source and the second light source may naturally be LED lamps of the same kind and may be LED lamps of different kinds.

A color of the light source can arbitrarily be selected. The first light source and the second light may select different light emitting colors. A color of the light source is selected in accordance with a use or an object thereof. For example, the first light source can be used as a light source for a stop & tail lamp by constituting the first light source by a red color light source and the second light source can be used as a light source for a turn lamp by constituting the second light source by a light source of amber color. Further, as other mode, for example, the first light source is used as a light source for a stop lamp by constituting the light source by a light source of red color and the second light source can be used as the light source for a tail lamp by constituting the second light source by a light source of red color.

The lens used in the invention includes the front light emitting face, the side end face and the rear face. The first light source is opposed to the side end face, and the side end face constitutes a light incident portion for making light of the first light source incident on the lens. Although the mode of the side end face is not particularly limited, a position, a shape, an angle or the like of the side end face is set such that incident light efficiently arrives at the reflecting portion mentioned later. It is preferable to make a face on which the light of the light source is incident (light introducing face) smooth from a view point of a light incident efficiency.

The side end face of the lens may be formed in a recess shape to incorporate the first light source. An efficiency of introducing the light of the light source is promoted thereby. Further, the first light source (or a portion thereof) can be contained at inside of the lens thereby, and also small-sized formation of the lamp is achieved. Further, when a light source for emitting light in a lateral direction (laterally radiating type LED lamp as a specific example) is used, normally, the light introducing portion of the mode is adopted.

A vicinity of the side end face of the lens can be formed more thick-walled than a lens edge portion (end portion on a side opposed to the side end face to which the first light source is opposed). For example, a thickness (distance between the front face and the rear face) of the vicinity of the side end face is made to be 2.5 times through 25 times as much as a thickness of the lens edge portion (the edge portion is constituted by a portion in which a distance from an outer edge of the lens is within 5% of a height of the lens. Further specifically, the vicinity of the side end face is formed to be the thickest and the thickness is made to be, for example, 15 mm through 50 mm, preferably, 25 mm through 40 mm. On the other hand, an average thickness of the lens edge portion is constituted by, for example, 3 mm through 20 mm, preferably 5 mm through 10 mm. It is effective for preventing that a portion of connecting the light source or the housing is observed from outside by way of the lens to use the thick-walled lens in this way. Further, it is also effective for the edge portion of the lens to emit light because an excellent light guiding operation is achieved.

A rear face of the lens includes pluralities of reflecting portions and transmitting portions alternately aligned consecutively in a direction of being remote from the side end face. By forming a side of the rear face of the lens in a step-like shape (in other words, forming a plurality of steps), the lens of the constitution can be provided.

Preferably, the reflecting portions and the transmitting portions are formed from the side end face over to a lens edge portion. That is, the constitution is constructed such that an edge of the reflecting portion disposed on the outermost side is brought into contact with the lens edge portion. According to such a constitution, even at the lens edge portion, light in a direction of the front light emitting face of the lens is generated by an operation of the reflecting portion, and therefore, the front light emitting face is facilitated to emit light by a sufficient brightness up to the edge (outer periphery).

In order to alleviate a nonuniformity in the brightness of the light radiated from the front light emitting face of the lens, it is preferable to design the shape of the lens such that a distance between the front face and the rear face of the lens becomes short continuously or in steps as being remote from the side end face. According to such a design, an efficiency of taking out light is promoted at a region remote from the first light source, as a result, light emission having a small brightness difference is achieved. Specifically, for example, the lens rear face may be formed in a step-like shape from the side end face to the lens edge portion.

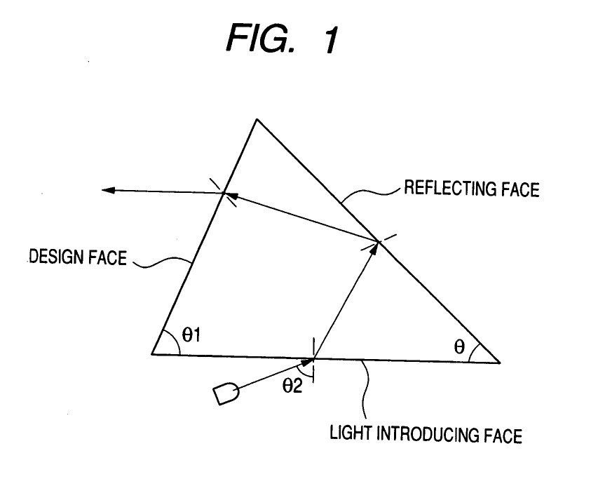

Light of light introduced from the side end face arriving at the reflecting portion is reflected by an interface at the reflecting portion and is converted into light in the direction of the front light emitting face. In this way, by the reflecting portion formed by utilizing a portion of the rear face, light in the front light emitting face direction is generated. Shapes, angles and the like of faces rectifying the respective reflecting portions can arbitrarily be set in consideration of an advancing direction of reflected light, a light distribution characteristic of a lamp or the like. As shown by FIG. 1, when an angle made by a face rectifying the reflecting portion (reflecting face) and a face rectifying the side end face (light introducing face) is designated by notation θ, an angle made by the front light emitting face (design face) and the light introducing face is designated by notation θ1, an angle of incidence of light relative to the light introducing face is designated by notation θ2, and a refractive index of the lens is designated by notation n, the following relationship is derived.

θ=[180°−θ₁−sin⁻¹{sin(90°−θ₁)/n}+sin⁻¹{(sin θ₂)/n}]/2 [Equation 2]

The angles of the faces rectifying the respective reflecting portions can be designed based on the relationship.

The transmitting portion of the lens rear face connects the reflecting portions. The transmitting portion is a plane and functions as an incident face for transmitting light of the second light source reflected by the reflecting portion mentioned later to be incident on the lens. It is preferable that the transmitting portion is an inclined face such that the light of the second light source is irradiated orthogonally thereto, because the light of the second light source is facilitated to be incident on the lens. The front light emitting face of the lens radiates light of the first light source and the second light source incident on the lens.

It is preferable that the front light emitting face of the lens satisfies the following relationship when the refractive index of a material of the lens is designated by notation n and the angle made by the front light emitting face and the side end face (light incident face) is designated by notation θ.

θ>2 sin⁻¹(1/n) [Equation 3]

When the relationship is satisfied, outer light incident on the side end face by way of the front light emitting face is totally reflected by the side end face. Thereby, the high design performance is achieved without optically recognizing the first light source present by being opposed to the side end face by way of the front light emitting face when the rear combination lamp is observed.

A material of the lens is not particularly limited so far as the material is a material having light guiding property, other than acrylic resin, polycarbonate resin, epoxy resin, glass or the like can be adopted. A light scattering agent may be included in the lens. Thereby, diffusion of light at inside of the lens is promoted and light having an excellent brightness balance is emitted from the front light emitting face. As the light scattering agent, for example, glass, a metal of aluminum or the like, a resin having a refractive index of light of the lens, silica or the like having a predetermined particle size can be used.

The reflecting face is provided on a rear side of the lens. The reflecting face reflects light of the second light source in a direction of the transmitting portion of the lens rear face. It is preferable that a mode (shape or angle) of the reflecting face is a mode of irradiating reflecting light orthogonally to the transmitting portion. Because reflected light is facilitated to be incident on the lens. It is preferable to form the reflecting face by subjecting a portion of an inner side face of a housing containing the first light source, the second light source and the lens to light reflection treatment, because a number of parts can be reduced. Further, because compact formation can be achieved.

According to an embodiment of the invention, a light guiding member functioning as a reflecting face is provided. Light of the second light source is incident on the light guiding member, reflected by an interface on a side of the light guiding member opposed to the lens, thereafter, radiated from a face on a side of the lens of the light guiding member. The reflecting face can be formed by subjecting a portion or a total of a surface of the light guiding member to light reflection treatment. Or, by inclining a portion or a total of the surface of the light guiding member by a predetermined angle, an interface thereof can be made to constitute the reflecting face. As a material of the light guiding member used here, other than acrylic resin, polycarbonate resin, epoxy resin, glass or the like can be adopted.

Examples of the invention will be explained as follows.

### Example 1

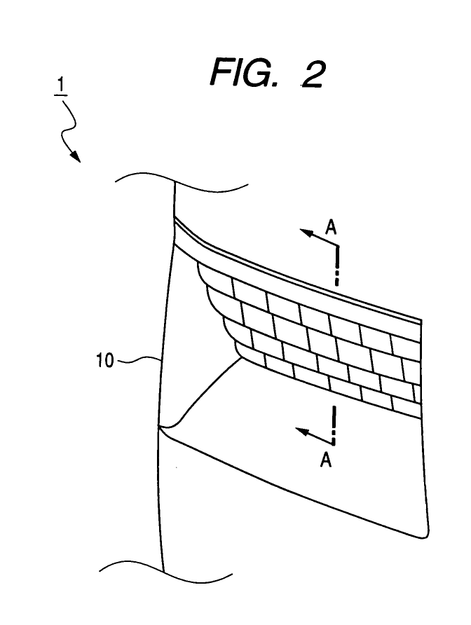

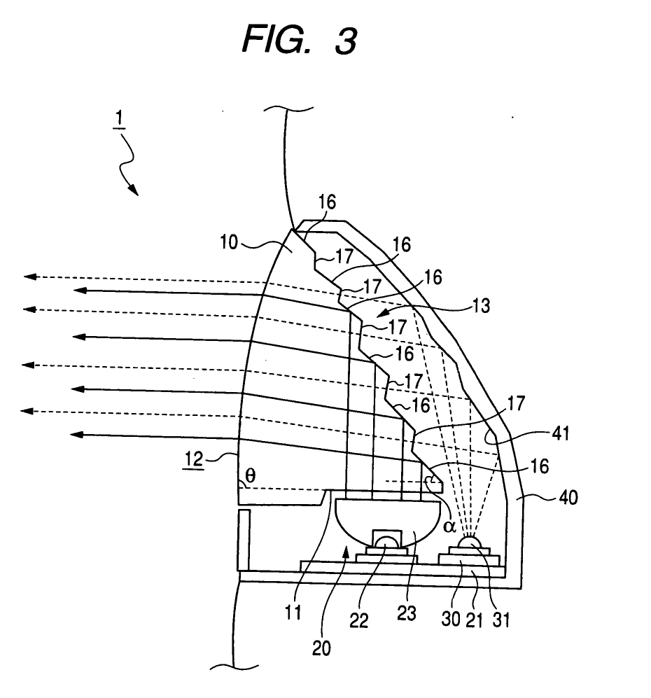

FIG. 2 is a perspective view showing a rear combination lamp 1 according to an example of the vehicular lamp of the invention. A sectional view of an A-A line position of FIG. 2 is shown in FIG. 3. As shown by FIG. 2, the rear combination lamp 1 includes a lens 10 made by acrylic resin having a refractive index of about 1.5, a first LED unit 20 opposed to a side end face 11, a second LED unit 30 arranged on a rear side of the first LED unit 20, and a housing 40. A front light emitting face 12 of the lens 10 is constituted by a gradually curved convex curved face. A radius of curvature of the curved face is 400 mm through 600 mm. The front light emitting face 12 satisfies the following equation when the refractive index of the lens 10 is designated by notation n, and an angle made by the front light emitting face 12 and the side end face 11 is designated by notation θ.

θ>2 sin⁻¹(1/n) [Equation 4]

On the other hand, a thickness (distance between the front light emitting face 12 and a rear face 13) an upper side edge portion of the lens 10 is about 5 mm and a thickness of a lower side edge portion (side end face) is about 40 mm. The rear face 13 of the lens 10 is constituted by a step-like shape, and 6 s of reflecting portions 16 are formed to be aligned consecutively by way of transmitting portions 17 such that the thickness (distance between the front light emitting face 12 and the rear face 13 of the lens 10) is reduced in steps in a direction of being remote from the side end face 11 of the lens 10, that is, as proceeding from a lower side to an upper side. The respective reflecting portions 16 are inclined to totally reflect light of the first LED lamp 20 to the side of the front light emitting face 12, and angles of inclination α are about 40° through about 50° (refer to FIG. 3). Further, the respective reflecting portions 16 are not subjected to a surface treatment for reflecting light. Also the transmitting portions 17 are not subjected to a surface treatment.

The first LED unit 20 and the second LED unit 30 are arranged on a base 21 and are unitized. The first LED unit 20 is constituted by an LED lamp 22 of a red color shelf type and an assisting lens 23 made of acrylic resin provided on a light emitting face side thereof. The assisting lens 23 converts light of the LED lamp 22 into light radiated from a total of an upper face of the assisting lens 23 in parallel. The upper face of the assisting lens 23 is substantially in parallel with the side face 11 of the lens 10 and is opposed to the side face 11. The second LED unit 30 includes an LED lamp 31 of an amber color shell type. The LED lamp 31 is arranged to emit light to an upper side and the emitted light radiates a reflecting face 41 mentioned later. Further, pluralities of the first LED units 20 and the second LED units 30 are aligned in a direction orthogonal to paper face of FIG. 2. Numbers of the first. LED unit 20 and the second LED unit 30 used are pertinently adjusted in accordance with a size of a light emitting region or a requested brightness.

The housing 40 contains the lens 10, the first LED unit 20, and the second LED unit 30. However, the front light emitting face 20 of the lens 10 is exposed to outside. The inner wall face 41 of the housing 40 is subjected to the reflection treatment by vapor deposition of Al. Thereby, a shape of the inner wall face 41 is constituted by a shape of a concave curved face bent to the rear face side of the lens 10. Further, a shape and an arrangement of the inner wall face 41 are adjusted such that the received light of the second LED unit 30 is reflected in a direction of the transmitting portion 17 of the lens 10 and reflected light thereof is irradiated orthogonally to the transmitting portion 17.

According to the rear combination lamp 1 having the above-described constitution, the first LED lamp 20 or the second LED lamp 30 is lighted in accordance with an input signal from a vehicle side. When a brake of the vehicle is stepped on, the input signal is emitted from the vehicle side to the first LED lamp 20. The first LED lamp 20 is lighted in accordance therewith, light thereof is first converted into parallel light advancing to the upper side, thereafter, incident on the lens 10 from the side end face 11 of the lens 10 (refer to an arrow mark indicated by a bold line of FIG. 3). The light incident on the lens 10 is guided at inside of the lens 10. Light arriving at the reflecting portion 16 is reflected in the direction of the front light emitting face 12 of the lens 10 and is radiated from the front light emitting face 12. Thereby, the rear combination lamp 1 emits light in red color and a stop lamp is lighted and observed. When a headlight of the vehicle is lighted, a portion of the first LED lamp 30 is lighted in accordance therewith to emit light of a brightness lower than that in lighting the stop lamp from the front light emitting face 12. Thereby, the rear combination lamp 1 emits light in red color by a low brightness and the tail lamp is lighted and observed.

On the other hand, when a turn signal is transmitted from the vehicle side, the second LED lamp 30 is lighted in accordance therewith. The light of the second LED lamp 30 advances in a direction of the inner wall face 41 and is reflected by the inner wall face 41. Reflected light radiates the transmitting portion 17 of the rear face of the lens 10 and is incident on the lens 10 by way of the transmitting portion 17 (refer to an arrow mark indicated by a broken line in FIG. 3). The incident light is guided at inside of the lens 10 and radiated from the front light emitting face 12. Thereby, the rear combination lamp 1 emits the light in amber color and the turn lamp is lighted and observed.

As described above, the stop lamp, the tail lamp and the turn lamp emit light from the same front light emitting face 12 in all of lighting modes, and therefore, a unified feeling is given to an observer.

Further, the refractive index n of the lens 10, and the angle θ made by the front light emitting face and the side end face 11 satisfy the above-described relationship, and therefore, outer light incident thereon by way of the front light emitting face 12 is totally reflected by the side end face 11. Therefore, when the rear combination lamp 1 is observed at turning off thereof, the first LED unit 20 and the second LED unit 30 are not optically recognized by way of the front light emitting face 12, and therefore, a high design performance is achieved. Further, the lens 10 is formed in a thick wall, and therefore, particular crystal feeling or depth feeling is given to the observer.

Meanwhile, the light of the LED lamp 22 is totally reflected by the interface of the reflecting portion 16, and therefore, it is not necessary to subject the reflecting portion 16 to the light reflection treatment. Thereby, simplification of fabricating steps and a reduction in fabrication cost can be achieved. Further, the inner wall face 41 of the housing 40 is utilized as a reflecting member, and therefore, it is not necessary to separately provide the reflecting member and a reduction in a number of parts and a reduction in fabrication cost in accordance therewith are achieved. Further, the constitution contributes also to compact formation of the rear combination lamp. The first LED unit 20 and the second LED unit 30 are provided on the base 21 and are unitized. Therefore, promotion of an attaching operability is achieved.

Further, although according to the example, the first LED unit 20 is used as a light source for the stop & tail lamp and the second LED unit 30 is used as a light source for the turn lamp, the embodiment is not limited thereto but the first LED unit 20 may be used as the light source for the turn lamp and the second LED unit 30 may be used as the light source for the stop & tail lamp.

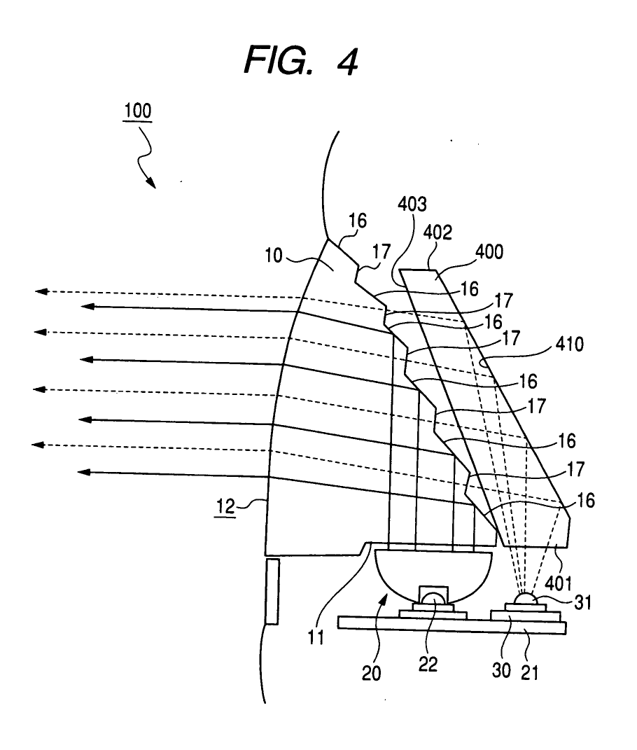

FIG. 4 shows a vertical sectional view of a rear combination lamp 100 constituting other example of the invention. Further, members the same as those of the rear combination lamp 1 are attached with the same notations and an explanation thereof will be omitted. A light guiding member 400 is provided on a rear side of the lens 10. A shape of the light guiding member 100 is constituted by a shape of substantially a flat plate and includes an end face 401 opposed to the second LED unit 30, an end face 402 on a side opposed to the end face 401, and a front face 403 on a side of the lens 10 and a rear face 410. According to the light guiding member 400, the rear face 410 is proximate to the front face 403 as being proximate from the end face 401 on a side of the second LED unit 30 to the end face 402 on an opposed side. That is, a thickness of the light guiding member 400 is reduced as being remote from the end face 401. The rear face 410 is not subjected to a reflection treatment. Further, the rear face 403 is inclined such that light of the LED lamp 31 is totally reflected in a direction of the lens 10.

According to the rear combination lamp 100, the light of the second LED lamp 30 is incident on the light guiding member 400 from the end face 401 of the light guiding member 400 and is guided in the light guiding member 400. Light arriving at the rear face 410 of the light guiding member 400 is reflected to the side of the lens 10. Reflected light is emitted from the front face 403 of the light guiding member 400 and emitted light arriving at the transmitting portion 17 of the rear face of the lens 10 is incident on the lens 10. The light incident on the lens 10 is guided in the lens 10 and is radiated from the front light emitting face 12. Also by the rear combination lamp 100, light of the LED lamp 31 is radiated from the front light emitting face 12 in accordance with a turn signal, the turn lamp is lighted and an effect equivalent to that of the rear combination lamp 1 is achieved.

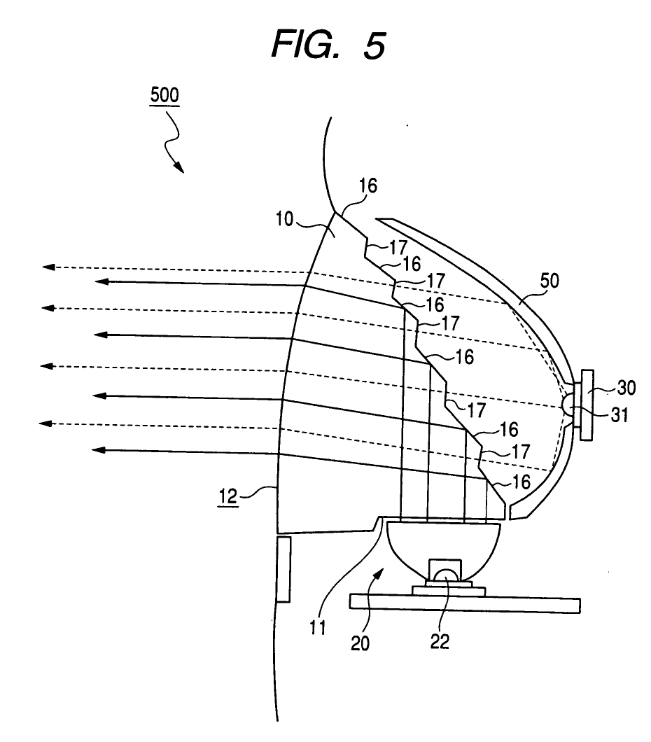

FIG. 5 shows a vertical sectional view of a rear combination lamp 500 constituting still other example. Further, members the same as those of the rear combinations lamps 1 and 100 are attached with the same notations and an explanation thereof will be omitted. A reflecting member 50 is provided on a rear side of the lens 10. The reflecting member 50 is a partial paraboloid of revolution and is arranged to cover a lower end through an upper end of the rear face of the lens 10. The second LED unit 30 is provided at a position in correspondence with an apex of the paraboloid of revolution of the reflecting member 50. The second LED unit 30 is arranged such that the LED lamp 31 is opposed to the rear face of the lens 10. An inner side face of the reflecting member 50 is subjected to light reflection treatment by vapor deposition of Al to constitute a reflecting face. The reflecting member 50 reflects light of the LED lamp 31 to a side of the rear face of the lens 10.

According to the rear combination lamp 500, light of the LED lamp 31 advances in a direction of the rear face of the lens 10 directly or by the reflecting member 50. Light arriving at the transmitting portion 17 of the rear face of the lens 10 is incident on the lens 10. Light incident on the lens 10 is guided in the lens 10 and is radiated from the front light emitting face 12. Also by the rear combination lamp 500, light of the LED lamp 31 is radiated from the front light emitting face 12 in accordance with the turn signal to light the turn lamp and a light emitting mode equivalent to those of the rear combination lamps 1 and 100 is shown. Further, according to the rear combination lamp 500, the second LED unit 30 is provided on the back face side of the lens 10, and therefore, in turning off the rear combination lamp 500, the second LED unit 30 is optically recognized from outside by way of the front light emitting face 12. When it is preferable that the LED unit is optically recognized from outside in view of design, the constitution of the rear combination lamp 500 becomes preferable.

The invention is utilized in a lamp showing two kinds or more of light emitting modes in various vehicles (passenger vehicle, bus, truck or the like). For example, the invention is preferably applicable to a rear combination lamp (constituted by combining two or more of stop lamp, tail lamp, turn lamp, and a back lamp).

The invention is not limited by the explanation of the embodiment and the example of the invention at all. Various modified modes are included in the invention within a range that is not deviated from the description of the scope of claims and can easily be conceived by the skilled person.

According to contents of papers, publicized patent application, and patent publication or the like clearly shown in the specification, all of the contents are cited by citation.

What is claimed is:

1. A vehicular lamp, comprising:
a first light source;
a second light source;
a lens having a front light emitting face, a side end face to which the first light source is opposed, and a rear face, the rear face including a plurality of reflecting portions and transmitting portions alternately aligned consecutively in a direction of being remote from the side end face; and
a reflecting face arranged rearward from the lens;
wherein light of the first light source is incident on the lens from the side end face of the lens, reflected by an interface of the reflecting portion, thereafter, radiated from the front light emitting face; and
wherein light of the second light source is reflected by the reflecting face, and is incident on the lens from the transmitting portion and radiated from the front light emitting face.

2. The vehicular lamp according to claim 1, wherein the reflecting face is a reflecting face formed at an inner wall face of a housing of containing the first light source, the second light source and the lens.

3. The vehicular lamp according to claim 1, wherein a light guiding member functioning as the reflecting face is provided, the light of the second light source is incident on the light guiding member, reflected by an interface on a side opposed to the lens of the light guiding member, thereafter, radiated from a face on a side of the lens of the light guiding member.

4. The vehicular lamp according to claim 1, wherein the light of the second light source reflected by the reflecting face is irradiated orthogonally to the transmitting portion.

5. The vehicular lamp according to claim 1, wherein an angle θ made by the front light emitting face and the side end face and a refractive index n of the lens satisfy a relationship of θ>2 sin⁻¹(1/n).

6. The vehicular lamp according to claim 1, wherein the first light source and the second light source are LED lamps.

7. The vehicular lamp according to claim 1, wherein the first light source and the second light source are arranged on the same board.
